(19) United States
(12) Patent Application Publication
(10) Pub. No.: US 2003/0177180 A1
(43) Pub. Date: Sep. 18, 2003

(54) Spot-specifying code providing method using communication between server and client terminal

(76) Inventors: Katsuharu Hosoe, Okazaki-City (JP); Masahiro Higuchi, Chiryu-City (JP)

Correspondence Address: NIXON & VANDERHYE, PC, 1100 N GLEBE ROAD, 8TH FLOOR, ARLINGTON, VA, 22201-4714, US

(21) Appl. No.: 10/337,894

(22) Filed: Jan. 8, 2003

(30) Foreign Application Priority Data
Mar. 15, 2002 (JP) 2002-72341

(51) Int. Cl. G06F 15/16

(52) U.S. Cl. 709/203

(57) ABSTRACT

A client terminal can obtain a spot-specifying code by accessing a server via the Internet. At first, when a user wants to obtain a spot-specifying code pertinent to a spot, the user appoints the spot on a map shown in a display of the client terminal. When the user appoints the several spots on the map, marks and numerals that indicate the appointed spots are displayed. Upon finishing appointment of all the spots, the user clicks a button of ‘ISUUE SPOT-SPECIFYING CODE.’ The server then converts coordinates of the appointed spots into the spot-specifying codes using a conversion table to make a file. The file is thereby downloaded to the terminal.

### CROSS REFERENCE TO RELATED APPLICATIONS

This application is based on and incorporates herein by reference Japanese Patent Application No. 2002-72341 filed on Mar. 15, 2002.

### FIELD OF THE INVENTION

The present invention relates to a spot-specifying code providing method in which a server provides the spot-specifying code to a client terminal through communicating with the client terminal.

### BACKGROUND OF THE INVENTION

Latitude and longitude are used to specify a location in a car navigation apparatus or an electronic map of a personal computer. Here, input of two parameters of the latitude and longitude is not so easy and mistaken order input of the two parameters fails to specify a location correctly. These problems involve poor operability of the apparatuses.

A method of simply specifying a location with one parameter is proposed in U.S. Pat. No. 6,006,160 (JP-A-H9-305108). The method adopts one unique code instead of two parameters of latitude and longitude. The unique code corresponds to a same-sized unit spot segmented in a meshed pattern on a map.

Referring to FIG. 12, a certain region map, i.e., a map throughout Japan, is segmented with the first mesh that has an area of 900 second latitude and 900 second longitude. The first mesh is next segmented with the second mesh that has an area of 30 second latitude and 30 second longitude. The second mesh is further segmented with the third mesh that has an area of 1 second latitude and 1 second longitude. Three types of the meshes are specified with three types of codes of a zone, block and unit codes, respectively. And a series of three types of codes thus forms a unique code of one parameter as shown in FIG. 13 to specify a spot.

The unique code is formed with nine or ten digits and is used as a spot-specifying code with a registered trademark ‘MAP CODE.’ Here, the spot-specifying code specifies a spot that has a certain range.

A spot-specifying code is obtained by using a car navigation apparatus that has a function of indicating the spot-specifying code. In such a function, the spot-specifying code is shown on a map in a display by setting a cursor to a desired spot on the map. However, when many spot-specifying codes are needed at once, the procedure for obtaining the codes becomes complicated and ineffective. In addition, all of the car navigation apparatuses are not equipped with the above function.

### SUMMARY OF THE INVENTION

It is an object of the present invention to provide a spot-specifying code providing method with which a user readily obtains a spot-specifying code as needed.

To attain the above and other objects, a spot-specifying code providing method is provided as follows. A server provides a spot-specifying code to a client terminal through communicating with the client terminal. At first the client terminal is urged to input necessary information for specifying a map including a spot whose spot-specifying code is required. The server generates map data based on the necessary information inputted to send them to the client terminal. At least one spot is appointed on a map that is displayed on a client terminal display based on the map data. The server obtains a coordinate pertinent to the appointed spot to convert it into a spot-specifying code. The spot-specifying code is thereby provided to the client terminal.

The spot-specifying code is provided to the client terminal by the server through communication. The method utilizes not only client terminal but also the server. It means that performance of the method is not restricted by capability of the client terminal. Therefore the user can readily obtain the desired spot-specifying code.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram of an executing structure of an embodiment of the present invention;

FIG. 2 is a flowchart of a spot-specifying code providing method of the embodiment;

FIG. 3 is a schematic diagram explaining a menu window in a client terminal display of the embodiment;

FIG. 4 is a schematic diagram explaining an address search window in the client terminal display of the embodiment;

FIG. 5 is a schematic diagram explaining a map window in the client terminal display of the embodiment;

FIG. 6 is a schematic diagram explaining a name input window in the client terminal display of the embodiment;

FIG. 7 is a schematic diagram explaining a file storing result in the client terminal display of the embodiment;

FIG. 8 is a flowchart of confirming a spot of the embodiment;

FIG. 9 is a schematic diagram explaining a file list window in the client terminal display of the embodiment;

FIG. 10 is a schematic diagram explaining a spot list window in the client terminal display of the embodiment;

FIG. 11 is a schematic diagram explaining a map for confirming a spot in the client terminal display of the embodiment;

FIG. 12 is a schematic diagram explaining a hierarchical structure of the spot-specifying code; and

FIG. 13 is a schematic diagram explaining the spot-specifying code.

### DETAILED DESCRIPTION OF THE PREFERRED EMBODIMENTS

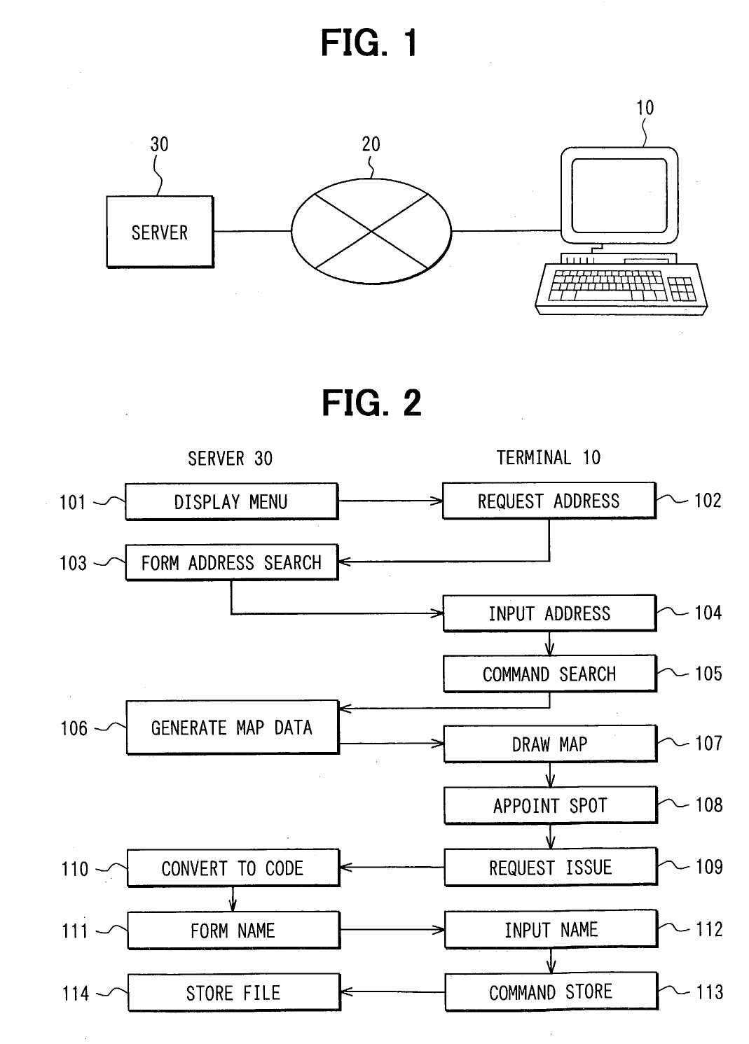

In an embodiment of the present invention shown in FIG. 1, it is assumed that a user operates a client terminal 10 (terminal) to obtain a spot-specifying code (spot code) by accessing a spot-specifying code conversion server 30 (server) via the Internet 20.

The server 30 is equipped with a program for providing the spot code, data base such as maps, addresses and phone numbers, and a conversion table between spot coordinates and spot codes. The terminal 10 is executable of a browser program and communicates with the server 30 via the Internet 20.

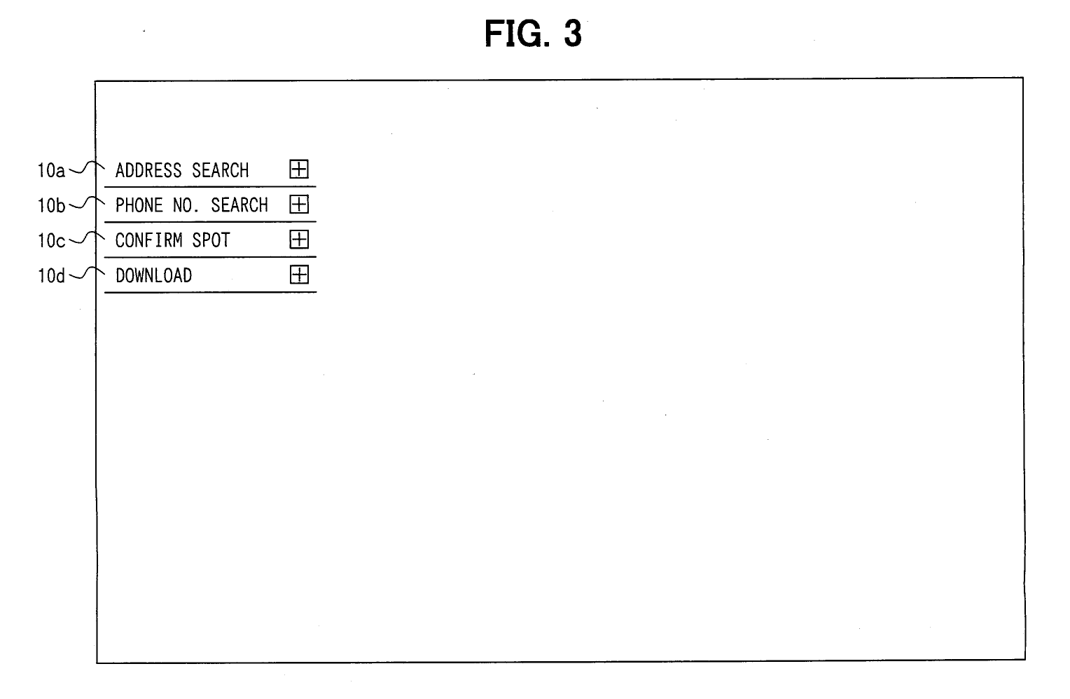

The user at first registers himself with the server 30 using the terminal 10 to be ready to be provided with the spot code. When the registered user is to receive provision of the spot code, the user accesses the server 30 using the terminal 10 then to execute a procedure for authentication with the server 30. Upon completion of the authentication, the server 30 controls to make the terminal 10 display a menu window at step 101 in FIG. 2. A display of the terminal 10 thus shows the menu window shown in FIG. 3. The window includes ‘REQUEST ADDRESS REQUEST’ 10a, ‘REQUEST PHONE NUMBER SEARCH’ 10b, ‘CONFIRM SPOT’ 10c and ‘DOWNLOAD’ 10d.

When the user obtains an area map corresponding to a desired spot code using an address, the user clicks ‘REQUEST ADDRESS SEARCH’ 10a for the terminal 10 to output a request for an address search at step 102.

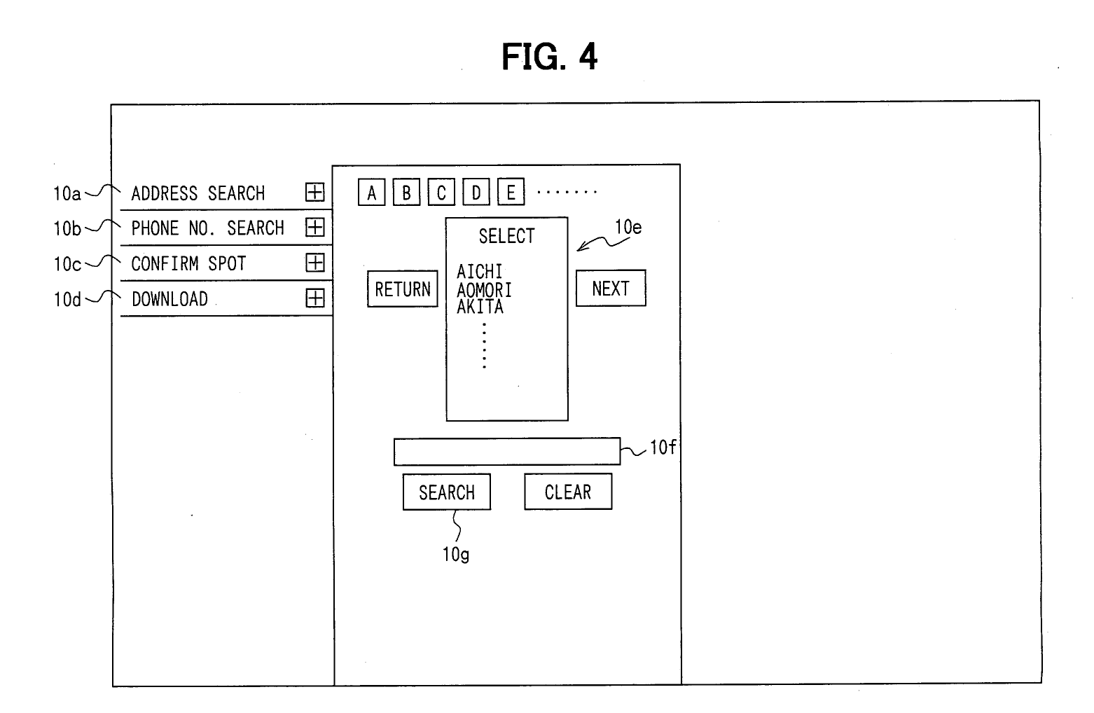

The server 30 forms an address search window at step 103 to control to make the terminal 10 display it. The terminal 10 thus displays a window shown in FIG. 4. Addresses are hierarchized into several levels such as prefecture, city and town. The user scrolls to select administrative district names shown in the address search window 10e or operates ‘RETURN’ or ‘NEXT’ to move into an upper or lower hierarchical level. The user thus selects a desired address at step 104. In addition, the user can directly input the address into an address input area 10f. As the user clicks ‘SEARCH’ button log after inputting the address, the terminal 10 outputs a command of an address search at step 105 to the server 30. The server 30 automatically determines a map scale according to an address level in the hierarchy to generate a map data pertinent to a map including the inputted address in the center of the map. The server sends the map data into the terminal 10 at step 106. The above scales are determined, for instance, as follows: A level of a city or town uses a scale of 1/250,000, a level of a block or street uses a scale of 1/10,000, a level of a house number uses a scale of 1/5,000, and a level of a room number uses a scale of 1/2,500.

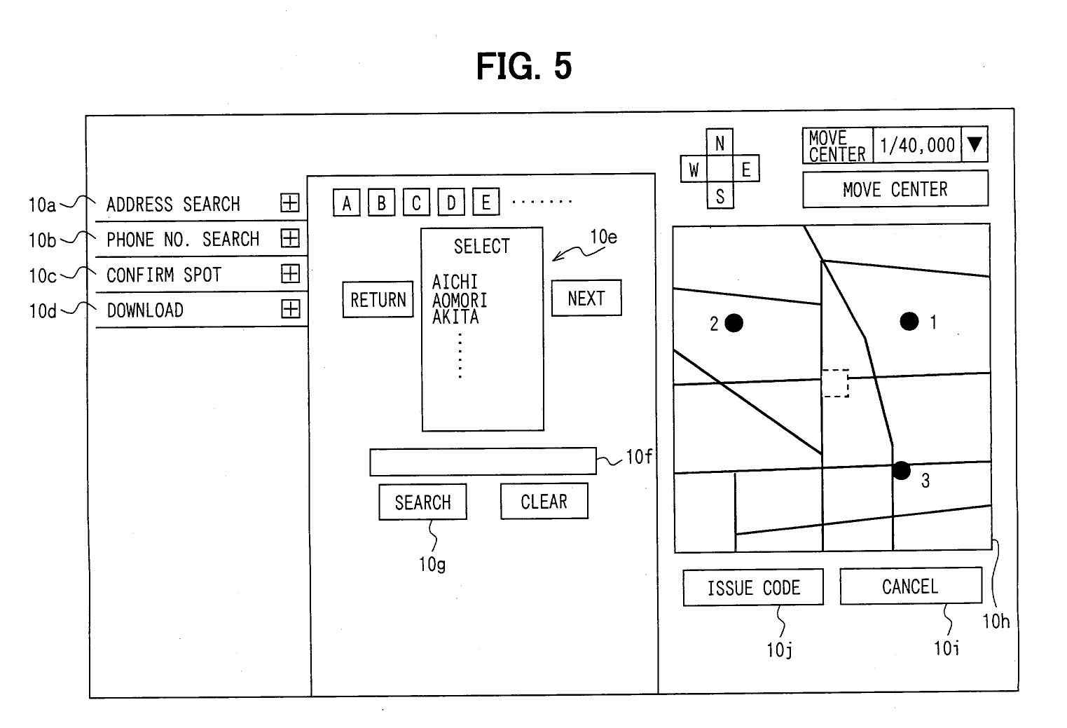

The terminal 10 displays the map based on the received map data at step 107. The display image of the terminal 10 is shown in FIG. 5. The map 10h shown in the display can be scale-changed using ‘SCALE’ button and be scrolled using ‘EAST,’ ‘WEST,’ ‘SOUTH’ and ‘NORTH’ buttons and ‘MOVE CENTER.’ Here, the user clicks to appoint a spot whose spot code is desired at step 108, so that the appointed spot is shown by a mark as a black circle shown in FIG. 5 with a numeral that means an appointed order such as 1, 2, and 3 shown in FIG. 5. As the user clicks ‘CANCEL’ button 10i, the appointed spot is cancel. The number of appointed spots is limited at a predetermined value, for instance ten.

The user clicks ‘ISSUE CODE’ 10j after completion of appointing all the spots, the terminal 10 sends to the server 30 in order each request for issuing and each coordinate data of the appointed spots at step 109. The coordinate data mean latitude and longitude.

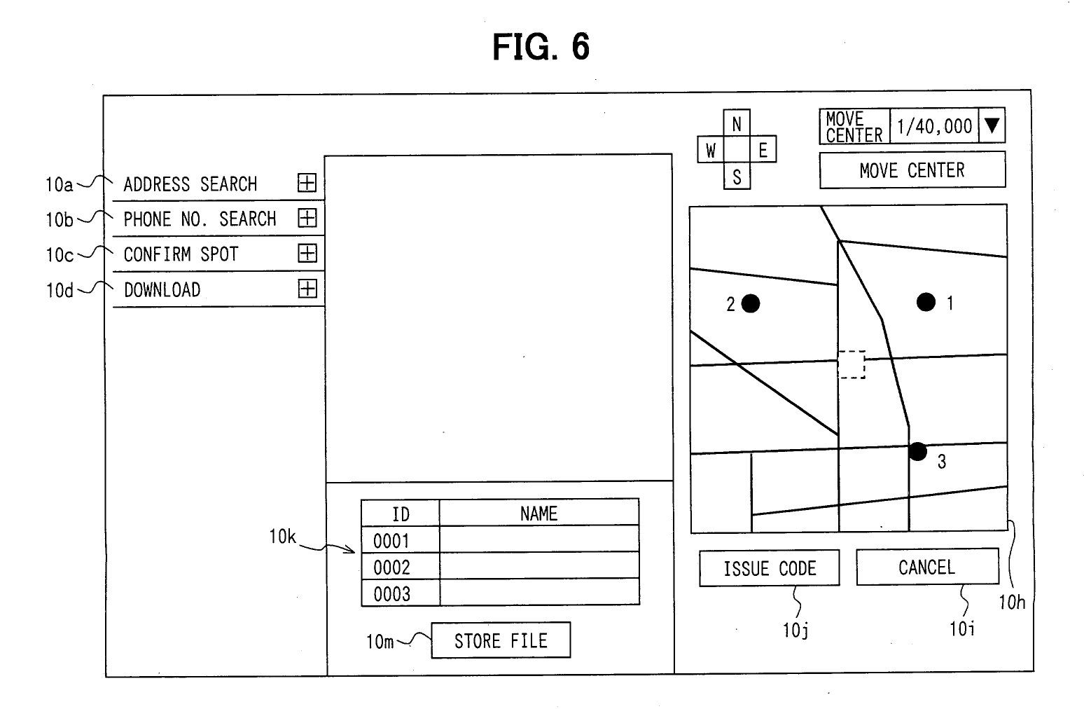

By the request of issuing the server 30 converts the coordinate data of each appointed spot into a spot code using a conversion table and forms a file at step 110. In the formed file, the converted spot code corresponds to each identification number of the spots (ID). At step 111, the server 30 controls to make the terminal 10 display a name input window in which the user inputs a name for each ID. The terminal 10 thus displays the name input window 10k shown in FIG. 6. The user inputs the name for the ID in the name input window 10k at step 112. The user can change the ID at this moment.

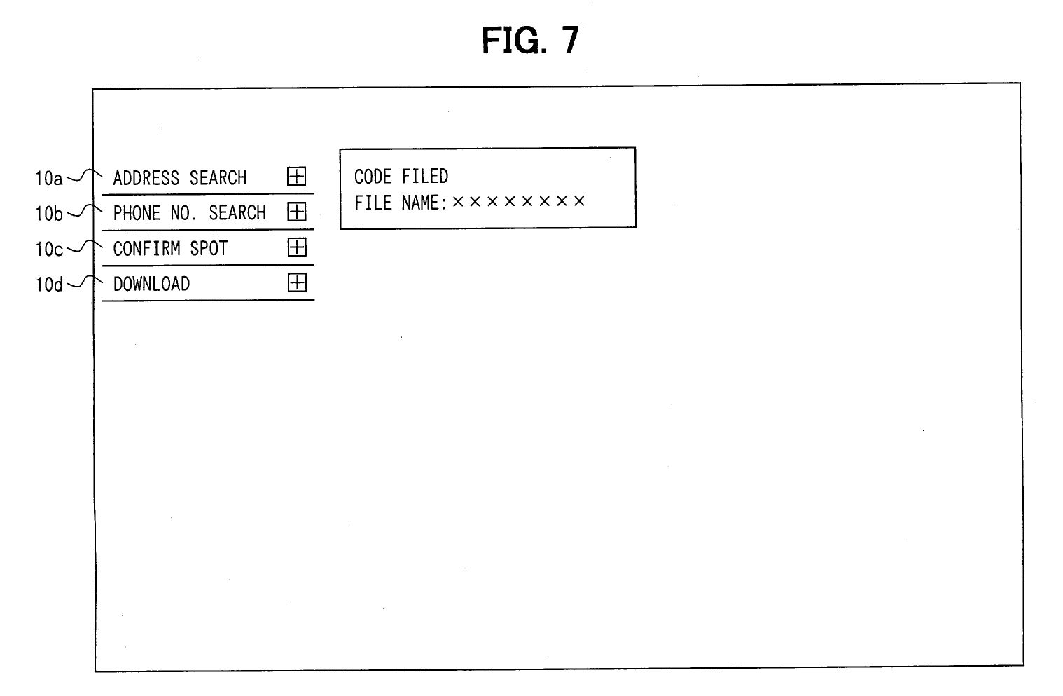

When the user clicks ‘FILE’ button 10m upon completion of inputting the name, the terminal 10 outputs a command of storing a file at step 113. The server 30 stores the file and controls to make the terminal 10 display a stored result of the file at step 114. The terminal 10 displays a window shown in FIG. 7 for the user to recognize the stored result by clicking a file name.

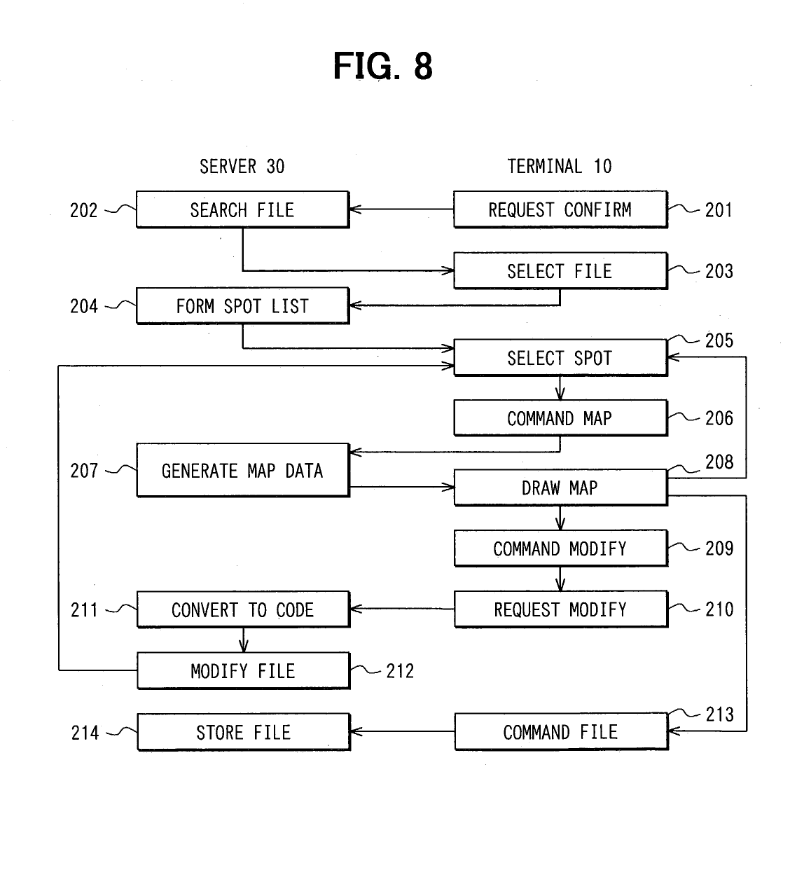

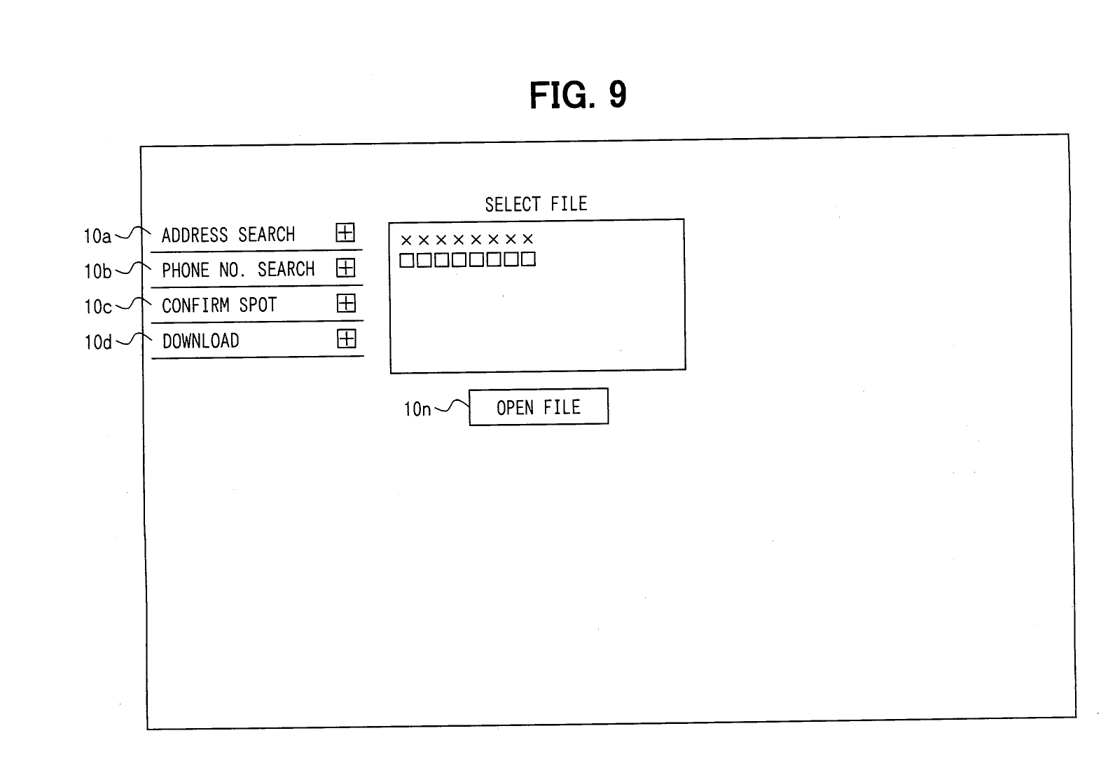

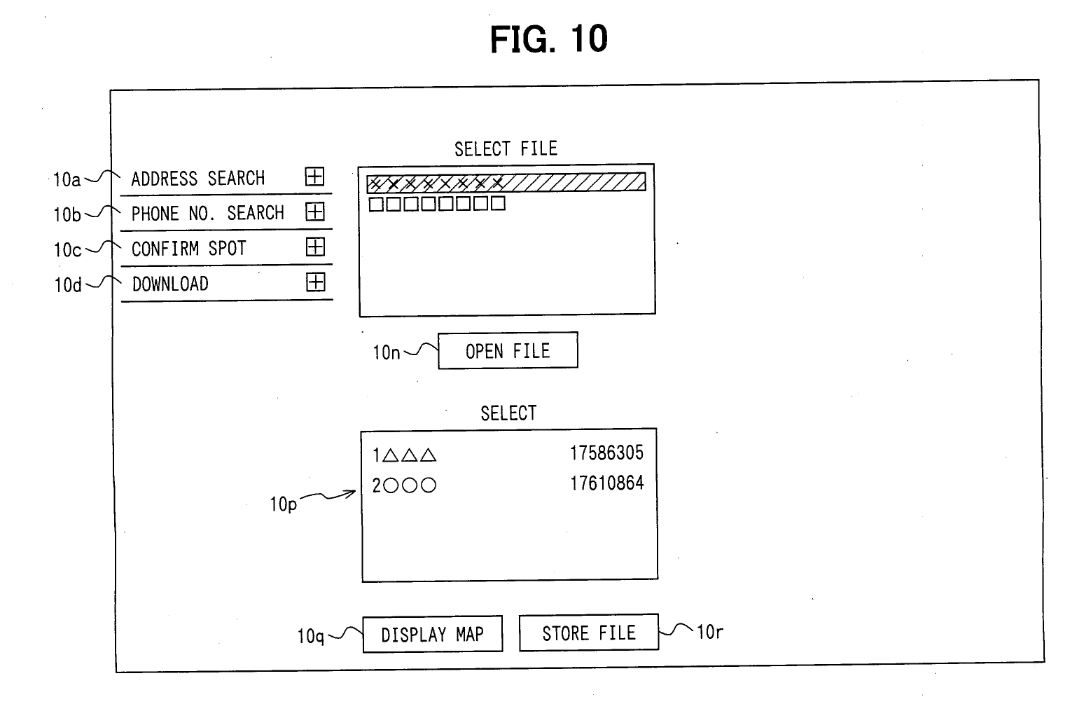

Next, a processing of confirming a spot stored in a file is explained, referring to FIG. 8. When the user clicks ‘CONFIRM SPOT’ button 10c, the terminal 10 outputs a request for confirming a spot at step 201. The server 30 searches a file registered by the user and controls to make the terminal 10 display a file list at step 202. The terminal 10 thus displays a window shown in FIG. 9, so that the user selects a desired file to click ‘OPEN FILE’ button 10n at step 203. The server 30 generates a spot list of the selected file and controls to make the terminal 10 display a spot list (including an ID, name and spot code) at step 204. The user selects one of spots in the spot list at step 205 and clicks ‘DISPLAY MAP’ button 10q, so that the terminal 10 outputs a command of displaying a map at step 206.

The server 30 generates map data pertinent to a map that includes in its center the selected spot that is specified with the spot, code. The server 30 then sends the map data to the terminal 10 at step 207.

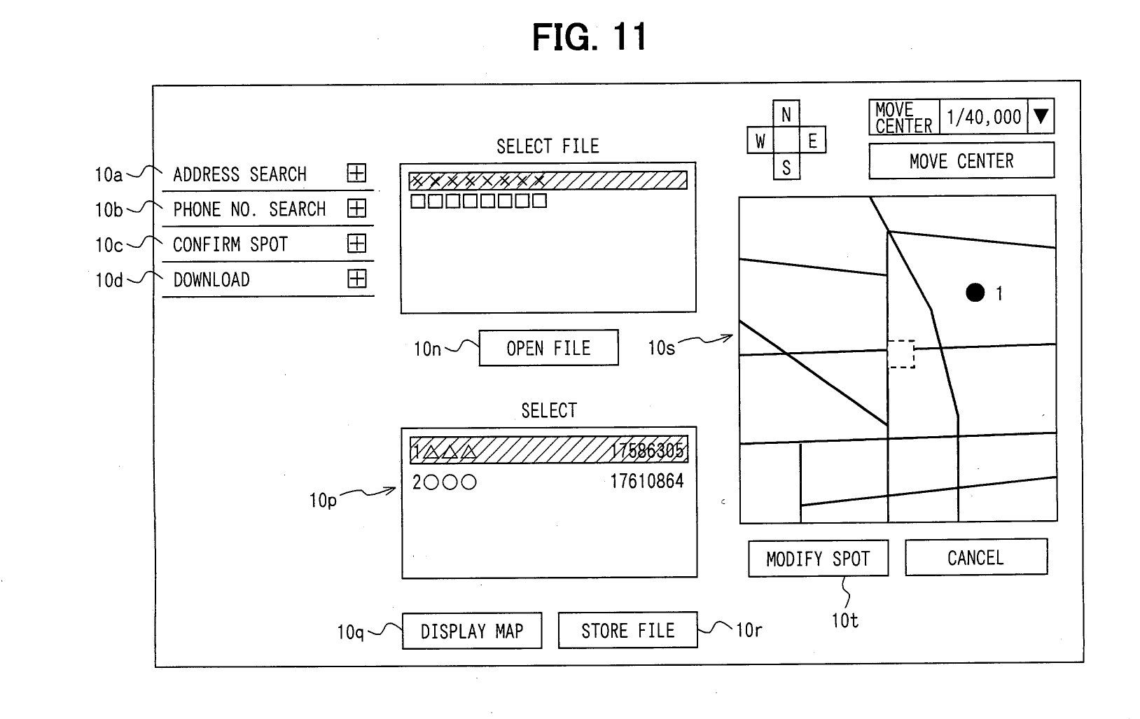

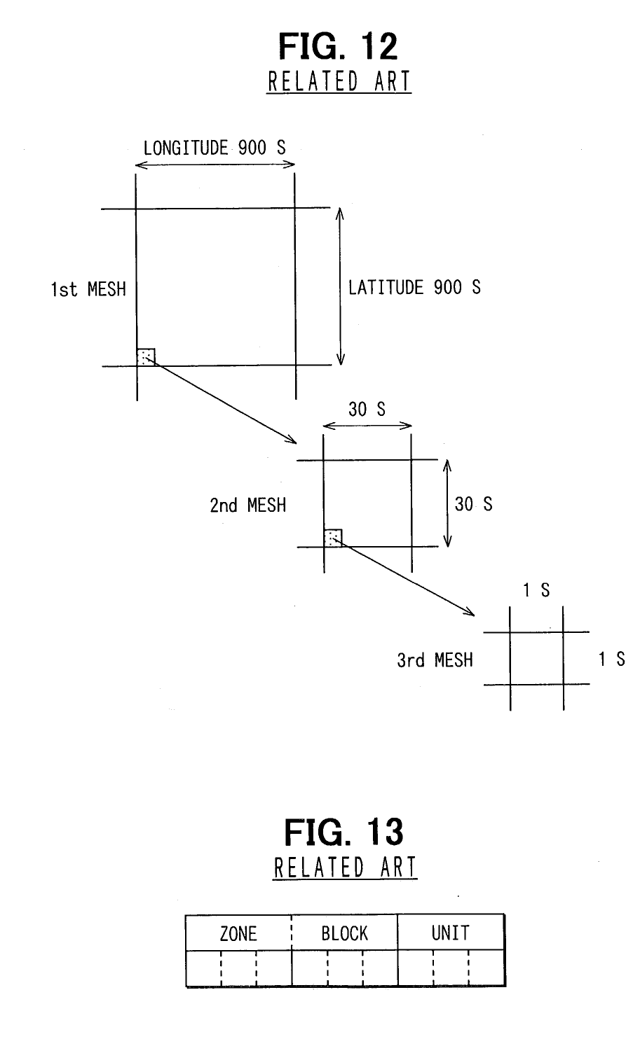

The terminal 10 displays the map 10s shown in FIG. 11 based on the received map data at step 208. In the map 10s, an ID (1) and a mark (black circle) of the selected spot are shown. The user thus determines whether the spot should be modified to other location. If the user wants to confirm another spot, the user selects another spot listed in the spot list 10p and clicks ‘DISPLAY MAP’ button 10q. The user can thereby confirm a location of each spot in the spot list 10q.

When the user determines modification of the spot, the user clicks to appoint a modified spot at step 209 and then clicks ‘MODIFY SPOT’ button 10t. The terminal then sends into the server 30 a request for modification and coordinate data of latitude and longitude of the modified spot at step 210. By the request of the modification the server 30 converts the map data of the spot into a spot code at step 211 and modifies the data of the file at step 212. The server then controls to make the terminal 10 display the modified spot list.

As the user clicks ‘STORE FILE’ button 10r after confirming all the spots, the terminal 10 outputs a command of storing the file at step 213. The server 30 stores the file and controls to make the terminal 10 display a stored result of the file at step 214.

If the user wants to download the stored file in the server 30, the user clicks ‘DOWNLOAD’ menu 10d for the server 30 to download the file to the terminal 10.

In the above embodiment, a spot pertinent to a desired spot code is searched though ‘REQUEST ADDRESS SEARCH’ 10a. However, it can be also searched through ‘REQUEST PHONE NUMBER SEARCH’ 10b. As the user clicks ‘REQUEST PHONE NUMBER SEARCH’ button 10b, the server 30 controls to make the terminal 10 display a phone number search window. The user inputs a phone number in the phone number search window and commands a search, so that the server 30 controls to make the terminal 10 display a spot pertinent to the phone number. As the user then clicks ‘ISSUE CODE’ button 10j, coordinate data of the spot is sent to the server 30 similarly to the processing through ‘REQUEST ADDRESS SEARCH.’ The server thereby converts the coordinate to a spot code.

In addition to the above embodiment, the server 30 can save issuing records of a spot code. Here, when the user requests issuing of a spot code, the server 30 determines whether the requested spot code has been issued. If the spot code has been already issued, the server 30 can notify the user of the effect.

What is claimed is:

1. A spot-specifying code providing method in which a server provides a spot-specifying code to a client terminal through communicating with the client terminal, wherein the spot-specifying code corresponds to a spot that is segmented in a meshed pattern on a map to be used for specifying the spot, the method comprising steps of:
receiving necessary information from the client terminal for specifying a map including a spot whose spot-specifying code is required;
generating map data based on the necessary information;
sending the map data to the client terminal;
obtaining a coordinate of at least one appointed spot on a map that is displayed on a display of the client terminal based on the map data;
converting the coordinate into a spot-specifying code; and
providing the spot-specifying code to the client terminal.

2. A spot-specifying code providing method according to claim 1,
wherein the necessary information is an address, and the generated map data is pertinent to a map that includes the address around the center of the map.

3. A spot-specifying code providing method according to claim 1, further comprising steps of:
receiving a request for confirming a given spot pertinent to a given spot-specifying code;
generating given map data pertinent to a given map including the given spot; and
making the client terminal display the given map and the given spot.

4. A spot-specifying code providing method according to claim 3, further comprising steps of:
obtaining a certain coordinate of a certain spot on the given map, wherein the certain spot is substituted for the given spot as a result of modifying appointment;
converting the certain coordinate into a certain spot-specifying code; and
providing the certain spot-specifying code to the client terminal.
